(19) United States
(12) Patent Application Publication
(10) Pub. No.: US 2022/0184541 A1
(43) Pub. Date: Jun. 16, 2022

(54) A PARTICLE PROTECTION DEVICE FOR A DEHUMIDIFIER

(71) Applicant: MUNTERS EUROPE AKTIEBOLAG, Kista (SE)

(72) Inventor: Joakim Edberg, Farsta (SE)

(21) Appl. No.: 17/440,043

(22) PCT Filed: Mar. 18, 2020
(86) PCT No.: PCT/EP2020/057510

§ 371 Date: Sep. 16, 2021

(30) Foreign Application Priority Data
Mar. 19, 2019 (SE) 1950339-0

(51) Int. Cl. B01D 46/00; B01D 53/26; B01D 53/06; B01D 46/44; F24F 3/14; F24F 13/28; F24F 11/39; F24F 11/77

(52) U.S. Cl. CPC B01D 46/0036; B01D 53/261; B01D 53/06; B01D 46/442; B01D 53/265; B01D 46/446; F24F 2140/50; F24F 3/1423; F24F 13/28; F24F 11/39; F24F 11/77; B01D 2257/80; F24F 2003/1464; B01D 46/0086

(57) ABSTRACT

The invention relates to a particle protection device (32) for a dehumidifier (1), the dehumidifier (1) comprising: a dehumidifying element (2), configured to separate moisture from air; a filter element (22) for separating particles from a process airflow (8); and a process air fan (20) for generating the process airflow (8) through the dehumidifying element (2) and through the filter element (22). Wherein the particle protection device (32) comprises: a control device (100); and a particle detector (30) arranged in communication with the control device (100) and configured to be arranged at the dehumidifier (1) to determine the particle concentration in the air that surrounds the dehumidifier (1) and that should be processed by the dehumidifier (1). The invention also relates to a method, performed by a control device (100) of a particle protection device (32), for protecting a dehumidifier (1) from particles. The invention also relates to a dehumidifier (1). The invention also relates to a computer program (P) computer-readable medium.

### TECHNICAL FIELD

The invention relates to particle protection device for a dehumidifier and a method, performed by a control device of a particle protection device according to the appended claims. The invention also relates to a dehumidifier, a computer program product and a computer-readable medium according to the appended claims.

### BACKGROUND AND PRIOR ART

Dehumidifiers, such as desiccant dehumidifiers and condensate dehumidifiers, are used for separating and removing moisture from air. The desiccant dehumidifier comprises a desiccant rotor which is the adsorption dehumidifying element in the dehumidifier. The desiccant rotor may be made of a composite material and designed with a large number of small air channels. The core of composite material may be impregnated with desiccant material that may be highly effective in attracting and retaining water vapour. The rotor has a center axis about which the the rotor is rotatable.

The desiccant rotor may be divided in two sections, a process section and a regeneration section. The airflow to be dehumidified, process air, will pass through the process section of the desiccant rotor and leave the rotor as dry air. Simultaneously, another air stream, which may be heated, flows through the regeneration section in an opposite direction, all the while the desiccant rotor may rotate slowly about its longitudinal axis. As the airflows through the process section, the desiccant material in the core of the desiccant rotor extracts moisture from the air. The thus treated air is returned to the enclosed space in a dehumidified state. The desiccant material is regenerated by the heated air stream, which may flow through the regeneration section of the desiccant rotor.

The humidity control technique in desiccant dehumidifiers rely on differences in vapour pressure in order to remove water vapour from air. Humid air has a relatively high water vapor pressure. In contrast, a dry desiccant surface of the desiccant rotor has a low water vapour pressure. When the moist air comes in contact with the desiccant surface, the water molecules move from the humid air to the desiccant surface in an effort to equalize the differential pressure. Thus, moisture will be separated and removed from air, and as a result the humid air will be dried.

The dehumidifying element in a condensate dehumidifier comprises an evaporator. A process air fan in the condensate dehumidifier is configured to generate a process airflow through the evaporator. The cold evaporator of a refrigeration device in the dehumidifier condenses moisture in the air, which moisture thus is removed from the air. Thereafter, the dried air is reheated by a condenser of the refrigeration device of the dehumidifier. Finally, the dehumidified, re-warmed air is released into the ambient space as dried air.

The airflow to be dehumidified, process air, may pass a filter element before the process air pass through the process section of the dehumidifying element and leave the dehumidifying element as dry air. The filter element will protect the dehumidifying element from clogging with particles that follows the process air. When the process air is passing the filter element, a majority of the particles are separated from the process air. The filter element should be cleaned at frequently intervals in order to prevent clogging of the filter and to achieve an effective dehumidifying process.

The document US2007056307 discloses a desiccant dehumidifier, which may comprise a desiccant rotor.

The document JP2001070733A discloses an air condition apparatus, which may be provided with an electric dust collecting unit, which may collect and remove airborne dust.

### SUMMARY OF THE INVENTION

Under certain conditions, the particle concentration in air is high. Especially, in spaces where water damage restoration must be performed, and where moisture should be removed from air, the particle concentration in air may temporarily be high due to grinding operations, spraying and other types of refurbishment. When a dehumidifier removes moisture from air in such a space, an accelerated clogging of the filter element of the dehumidifier will take place. In addition, particles may pass the filter element and clog the dehumidifying element, such as a desiccant rotor or an evaporator of the dehumidifier. Under such circumstances, the filter element and the dehumidifying element must be frequently inspected for functionality. In addition, the filter element must be cleaned or replaced frequently in order to prevent clogging of the filter.

There is a need to develop a particle protection device for a dehumidifier and a method, performed by a control device of a particle protection device, which prevents clogging of an air filter element. There is also a need to develop a particle protection device for a dehumidifier and a method, performed by a control device of a particle protection device, which reduces the need of inspection of the dehumidifier. There is also a need to develop a particle protection device for a dehumidifier and a method, performed by a control device of a particle protection device, which decreases demands on an air filter element.

The object of the invention therefore is to develop a particle protection device for a dehumidifier and a method, performed by a control device of a particle protection device, which prevents clogging of an air filter element.

Another object of the invention is also to develop a particle protection device for a dehumidifier and a method, performed by a control device of a particle protection device, which reduces the need of inspection of the dehumidifier.

Further objects of the invention are also to develop a particle protection device for a dehumidifier and a method, performed by a control device of a particle protection device, which decreases demands on an air filter element.

These objects are achieved with the above-mentioned particle protection device for a dehumidifier according to the appended claims.

According to the invention a particle protection device for a dehumidifier is provided, the dehumidifier comprising: a dehumidifying element, configured to separate moisture from air; a filter element for separating particles from a process airflow; and a process air fan for generating the process airflow through the dehumidifying element and through the filter element; wherein the particle protection device comprises: a control device; and a particle detector arranged in communication with the control device and configured to be arranged at the dehumidifier to determine the particle concentration in the air that surrounds the dehumidifier and that should be processed by the dehumidifier.

This particle protection device for a dehumidifier will save the filter element and also the dehumidifying element from clogging. Instead or in combination of detecting a clogged filter element, the particle concentration in the surrounding air, that should be processed by the dehumidifier, is detected by the particle detector. Having information of the particle concentration, the process airflow through the filter element may be interrupted. Thus, air having a high particle concentration will not reach the filter element.

According to the invention a method, performed by a control device of a particle protection device, for protecting a dehumidifier from particles is provided. The dehumidifier comprising: a dehumidifying element, configured to separate moisture from air; a filter element for separating particles from a process airflow; and a process air fan for generating the process airflow through the dehumidifying element and through the filter element; the method comprises the steps of: determining the particle concentration the air that surrounds the dehumidifier and that should be processed by the dehumidifier by means of a particle detector arranged at the dehumidifier; and reducing or deactivating the process airflow when the particle concentration in the air is above a threshold value.

Under conditions when the particle concentration in air is temporarily high, the process airflow is reduced. This may be possible by reducing the speed of the process air fan. Alternatively, the process airflow is deactivated, which is possible by shutting off the dehumidifier or putting the dehumidifier in a standby mode, which will deactivate the process air fan. When the dehumidifier is shut off or put in a standby mode, no air will pass the filter element and the dehumidifying element. Thus, an accelerated clogging of the filter element and the dehumidifying element is prevented. As a result, a frequently inspection for functionality of the dehumidifier can be avoided. In addition, the need of frequently cleaning or replacement of the filter element is avoided. Due to the particle detector, the demands on the filter element can be reduced, allowing selection of either filter elements with lower pressure or lower drop.

In order to determine actual particle concentration in the ambient air when the dehumidifier has been fully stopped, the process air fan may be restarted or temporarily restarted as to circulate ambient air to the sensor. This procedure may be conducted at suitable intervals as to achieve sufficient operation. When the particle concentration in air reduces, the dehumidifier is turned on and the process air fan is activated. Thus, after the dehumidifier has been shut off or has been put in a standby mode by deactivating the process air fan, the particle concentration in the air, surrounding the dehumidifier, is detected by the particle detector by restarting or temporarily restarting the process air fan, so as to circulate ambient air to the sensor.

It is also possible to let the dehumidifier continue its operation with a reduced process airflow by adjusting the process air fan speed. In this case smaller airflow can partly be compensated by the fact that the process airflow will reach a lower dew point, at the same time as the clogging process of the filter element at least is significantly slowed down. Depending on actual circumstances, the responsive behavior of the process air fan speed may be adjusted by setting parameters as to achieve desired combination of protection, energy efficiency and moisture removal. It can also be favorable to avoid a complete stopping of the process air fan in order to avoid after-heat in a heater element and to avoid possibly mechanical stresses related to full thermal cycling. When stopping the process air fan also other components in the dehumidifier are stopped.

Additional objectives, advantages and novel features of the invention will be apparent to one skilled in the art from the following details, and through exercising the invention. While the invention is described below, it should be apparent that the invention is not limited to the specifically described details. One skilled in the art, having access to the teachings herein, will recognize additional applications, modifications and incorporations in other areas, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various diagrams, and in which:

FIG. 1 schematically illustrates the principle of a desiccant dehumidifier according to an example,

FIG. 2 schematically illustrates a particle protection device for a desiccant dehumidifier according to an example,

FIG. 3 schematically illustrates a particle protection device for a condensate dehumidifier according to an example,

FIG. 4 shows a flow chart for a method, performed by a control device of a particle protection device according to an example, and

FIG. 5 schematically illustrates a control unit or computer according to an example.

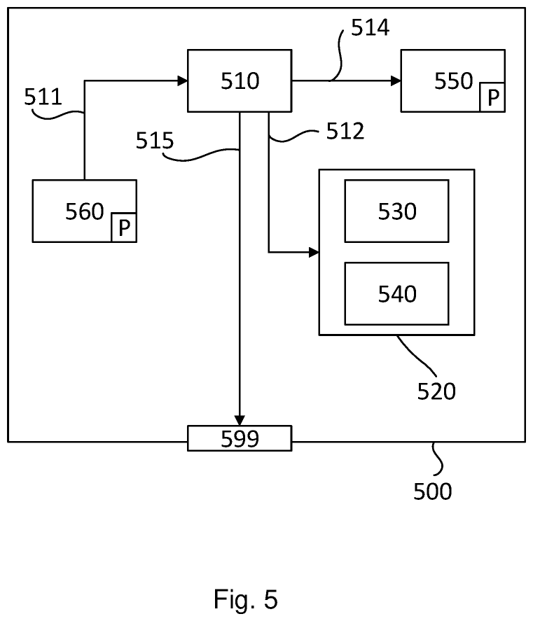

### DETAILED DESCRIPTION OF THE DRAWINGS

The particle protection device according to the present disclosure prevents or reducing the risk for clogging of an air filter element of a dehumidifier. Such a dehumidifier may be a desiccant dehumidifier and condensate dehumidifier. The device also reduces the need of inspection of the dehumidifier. In addition, the demands on the air filter element decreases.

According to the present disclosure a particle protection device for a dehumidifier is provided, the dehumidifier comprising: a dehumidifying element, configured to separate moisture from air; a filter element for separating particles from a process airflow; and a process air fan for generating the process airflow through the dehumidifying element and through the filter element; wherein the particle protection device comprises: a control device; and a particle detector arranged in communication with the control device and configured to be arranged at the dehumidifier to determine the particle concentration in the air that surrounds the dehumidifier and that should be processed by the dehumidifier.

This particle protection device for the dehumidifier will save the filter element and also the dehumidifying element from clogging. Instead or in combination of detecting a clogged filter element, the particle concentration in the surrounding air, that should be processed by the dehumidifier, is detected by the particle detector. Having information of the particle concentration, the process airflow through the filter element may be interrupted. Thus, air having a high particle concentration will not reach the filter element. The dehumidifier may be a desiccant dehumidifier or a condensate dehumidifier. The desiccant dehumidifier comprises a desiccant rotor, which may be made of a composite material and provided with a plurality of channels. The core of composite material is impregnated with desiccant material that is highly effective in attracting and retaining water vapour. The process air, will pass through the process section of the desiccant rotor and leave the rotor as dry air. The rotor has a center axis about which the the rotor is rotatable. In order to restore the characteristics of attracting and retaining water vapour, the channels of the desiccant rotor should be protected from clogging by particles in the process air. The filter element will separating particles from the process airflow and thus prevent the particles from reaching the channels of the desiccant rotor. The filter element may comprise a paper or a tissue with a certain porosity. The filer element will allow the process air to pass the paper or tissue, but particles in the process air will be stopped by the filter element and stay in the paper or tissue. When a certain amount of particles have been stopped by the filter element, and thus stay in the filter element, the particles in the filter element may prevent the process air to pass the filter element. In such situation, the filter element is clogged by particles. The process air fan generates the process airflow through the channels of the desiccant rotor and through the filter element. The process air fan may be arranged downstream of the desiccant rotor and of the filter element. The process air fan will thus draw the process air through the channels of the desiccant rotor and through the filter element. Alternatively, the process air fan may be arranged upstream of the desiccant rotor and of the filter element. The process air fan will thus push the process air through the channels of the desiccant rotor and through the filter element. The process air fan may alternatively be arranged upstream of the desiccant rotor and downstream of the filter element. The process air fan will thus push the process air through the channels of the desiccant rotor and draw the process air through the filter element.

The dehumidifying element in a condensate dehumidifier comprises an evaporator. A process air fan in the dehumidifier is configured to generate a process airflow through the evaporator. The evaporator should be protected from clogging by particles in the process air. The filter element will separating particles from the process airflow and thus prevent the particles from reaching the evaporator.

The particle protection device comprises a control device. The control device comprises a non-volatile memory, a data processing unit and a read/write memory. The non-volatile memory has a first memory element in which a computer programme, e.g. an operating system, is stored for controlling the function of the device. The device further comprises a bus controller, a serial communication port, I/O means, an A/D converter, a time and date input and transfer unit, an event counter and an interruption controller. The non-volatile memory has also a second memory element, which comprises a non-volatile memory, a data processing unit and a read/write memory. The non-volatile memory has a first memory element in which a computer programme, e.g. an operating system, is stored for controlling the function of the device. The device further comprises a bus controller, a serial communication port, I/O means, an A/D converter, a time and date input and transfer unit, an event counter and an interruption controller. The non-volatile memory has also a second memory element. The particle detector is arranged in communication with the control device. The particle detector is configured to be arranged at the dehumidifier to determine the particle concentration in the air that surrounds the dehumidifier and that should be processed by the dehumidifier. The particle detector may be arranged at the dehumidifier, adjacent to the dehumidifier or at a distance from the dehumidifier. The particle detector may be arranged in a common space with the dehumidifier, in which space air should be processed or treated by the dehumidifier. Thus, the particle detector determine the particle concentration in the air that that should be processed by the dehumidifier. Information about the particle concentration in the air that that should be processed by the dehumidifier is communicated from the particle detector to the control device. The communication between the particle detector and the control device may be transmitted wireless or by a wire or cable.

According to an example, the dehumidifying element comprises a desiccant rotor of a desiccant dehumidifier, which desiccant rotor is provided with a plurality of channels, and wherein the process air fan is configured to generate the process airflow through the channels of the desiccant rotor.

The desiccant dehumidifier comprises a desiccant rotor. A number of channels are arranged in the desiccant rotor. The channels may extend from one side to the other of the desiccant rotor. The channels are parallel to a center axis of the desiccant rotor. The process airflow may pass through the channels, so that the process air is treated by reducing water or a fluid in the process air.

According to an example, the dehumidifying element comprises an evaporator of a condensate dehumidifier, and wherein the process air fan is configured to generate the process airflow through the evaporator of a condensate dehumidifier. The process air fan in the condensate dehumidifier is configured to generate the process airflow through the evaporator. The evaporator may be a part of a refrigeration device in the dehumidifier. The cold evaporator condenses moisture in the air, so that moisture is removed from the air. Thereafter, the dried air is reheated by a condenser of the refrigeration device of the dehumidifier. Finally, the dehumidified, re-warmed air is released into the ambient space as dried air.

According to an example, the particle detector is adapted to be arranged at the filter element in the process airflow upstream of the filter element.

The process air to be treated by the dehumidifier should pass the particle detector before reaching the filter element. It is thus possible for the particle detector to detect the particle concentration in the process air before it reaches the filter element. The information about the detected particle concentration in the process air is communicated to the control device, which determines if the particle concentration in the process air is acceptable or not.

According to an example, the particle detector is adapted to be arranged in the filter element and constitutes an integrated part of the filter element.

The filter element may be arranged in or at an opening of the dehumidifier. Process air passes the filter element before the process air is processed by the dehumidifier. The particle detector arranged in the filter element detects the particle concentration in the process air when it reaches and pass through the filter element. The information about the detected particle concentration in the process air is communicated to the control device, which determines if the particle concentration in the process air is acceptable or not.

According to an example, the particle detector comprises an optical detector element for detecting the particle concentration.

Particles that passes the optical detector element of the particle detector will be detected and registered. The particle concentration in the process air will be detected in the airflow. The airflow passes the optical detector element and the number of detected particles detected in relation to a time will correspond to a certain particle concentration in the air. The information about the number of particles detected by the optical detector element in relation to time will be communicated to the control device, which calculates the particle concentration in the process air. The control device will also determine if the particle concentration in the process air is acceptable or not.

According to an example, the control device is configured to determine the particle concentration in the air that surrounds the dehumidifier and which air should be processed by the dehumidifier.

The particle detector is arranged in communication with the control device. The particle detector detects particles in the air that surrounds the dehumidifier and that should be processed by the dehumidifier. The air to be processed by the dehumidifier is the process air. The particle detector detects particles and communicates the information to the control device. The control device receives the information about the particles and will determine the particle concentration based on the received information. The information received by the control device may be a number of detected particles during a period of time.

According to an example, the control device is configured to reduce the process airflow when the particle concentration in the air is above a threshold value.

Under conditions when the particle concentration in air is above a threshold value, the process airflow is reduced. This may be possible by reducing the speed of the process air fan.

According to an example, the control device is configured to deactivate the process airflow when the particle concentration in the air is above a threshold value.

Under conditions when the particle concentration in air is above a threshold value, the process airflow is deactivated, which is possible by shutting off the dehumidifier or putting the dehumidifier in a standby mode, which will deactivate the process air fan.

According to an example, the particle protection device further comprising: a first pressure sensor adapted to be arranged upstream of the filter element; and a second pressure sensor adapted to be arranged downstream of the filter element.

When the pressure difference in the process airflow before and after the filter element has reached a predetermined pressure difference, the filter element may be clogged with particles, which reduces the airflow through the filter element. When the pressure difference reaches predetermined pressure difference, the control device indicates that the filter element should be cleaned or be replaced.

According to the present disclosure, a dehumidifier is provided. The dehumidifier, comprising the above-mentioned particle protection device.

According to the present disclosure, a method performed by a control device of a particle protection device, for protecting a dehumidifier from particles is provided. The dehumidifier comprising: a dehumidifying element, configured to separate moisture from air; a filter element for separating particles from a process airflow; and a process air fan for generating the process airflow through the dehumidifying element and through the filter element; the method comprises the steps of: determining the particle concentration in the air that surrounds the dehumidifier and that should be processed by the dehumidifier by means of a particle detector arranged at the dehumidifier; and reducing or deactivating the process airflow when the particle concentration in the air is above a threshold value.

Under conditions when the particle concentration in air is temporarily high, the process airflow is reduced. This may be possible by reducing the speed of the process air fan. Alternatively, the process airflow is deactivated, which is possible by shutting off the dehumidifier or putting the dehumidifier in a standby mode, which will deactivate the process air fan. When the dehumidifier is shut off or put in a standby mode, no air will pass the filter element and the dehumidifying element. When the dehumidifier is operated at reduced airflow, the clogging process is slowed down. Thus, an accelerated clogging of the filter element and the rotor is prevented. As a result, a frequently inspection for functionality of the dehumidifier can be avoided. In addition, the need of frequently cleaning or replacement of the filter element is avoided. Due to the particle detector, the demands on the filter element can be reduced.

According to an example, the method comprises the further step of increasing or activating the process airflow when the particle concentration in the air is below the threshold value.

After the process airflow has been reduced or been deactivated by reducing the speed of the process air fan or deactivating the process air fan, the particle concentration in the air, surrounding the dehumidifier, is detected by the particle detector. The process air fan may frequently be activated in short periods for creating a short airflow through the particle detector. When the particle concentration in air is reduced and when the particle concentration in the air is below the threshold value, the dehumidifier is turned on and the process air fan is activated.

According to an example, the method comprises the further steps of determining the pressure difference between a pressure detected by a first pressure sensor arranged upstream of the filter element and second pressure sensors arranged downstream of the filter element; and indicating when the determined pressure difference is above a threshold value.

When the pressure difference in the process airflow before and after the filter element has reached a predetermined pressure difference, the filter element may be clogged with particles, which reduces the airflow through the filter element. When the determined pressure difference is above a threshold value, an indication is received. The control device may thus indicate that the filter element should be cleaned or be replaced.

The present disclosure also relates to a computer program comprising instructions which, when the program is executed by a computer, causes the computer to carry out the method disclosed above. The invention further relates to a computer-readable medium comprising instructions, which when executed by a computer causes the computer to carry out the method disclosed above.

The present disclosure will now be further illustrated with reference to the appended figures.

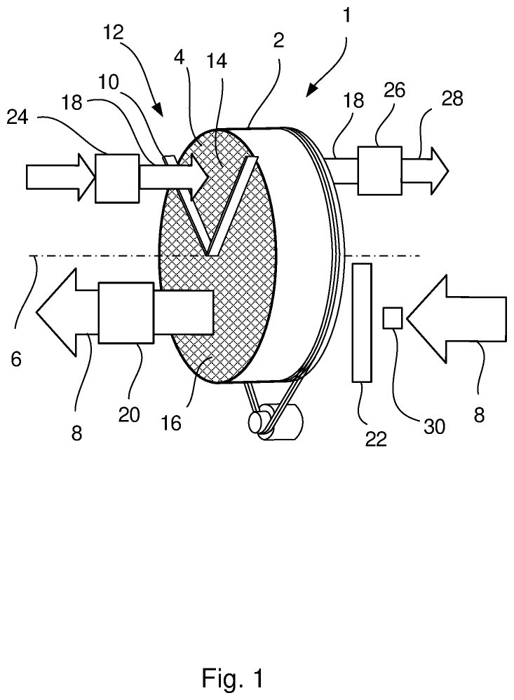

FIG. 1 schematically illustrates the principle of a desiccant dehumidifier 1 according to an example. The desiccant dehumidifier 1 comprises a desiccant rotor 2. A number of channels 4 are arranged in the desiccant rotor 2. The channels 4 may extend from one side to the other of the desiccant rotor 2. The channels 4 are parallel to the center axis 6 of the desiccant rotor 2. A process airflow 8 may pass the channels 4. The desiccant rotor 2 is adapted to treat the process air by reducing water in the process air that may pass through the channels 4 of the desiccant rotor 2. A generally V-shaped, partition member 10 segregates a pie-shaped portion 12 of the desiccant rotor 2 from the remaining portion thereof to define a reactivation section 14 of the desiccant rotor 2. The remaining portion of the desiccant rotor 2 defines a process section 16. The reactivation section 14 of the desiccant rotor 2 may occupies about one quarter to one third of the surface area of the desiccant rotor 2. In the desiccant dehumidifier 1 the process air to be dehumidified is allowed to flow through the channels 4 in the desiccant rotor 2. A heated reactivation airflow 18 is, at the same time, allowed to pass in counterflow through the reactivation section 14 of the desiccant rotor 2. The reactivation airflow 18, increases the temperature of the desiccant rotor 2, so that the desiccant rotor 2 gives off its moisture which is then carried away by the reactivation airflow 18. The dried desiccant material in the desiccant rotor 2 is rotated into the process section 16, where it once again absorbs moisture from the process air. A process air fan 20 is configured for drawing process air from the air that surrounds the desiccant dehumidifier 1 and urging it to flow through a filter element 22 and the process section 16 of the desiccant rotor 2 in order to remove moisture from the process air. Downstream of the process section 16 of the desiccant rotor 2 the dehumidified process airflow 8 is exhausted into the enclosed space that surrounds the desiccant dehumidifier 1. The reactivation air is drawn from the air that surrounds the desiccant dehumidifier 1 and heated in a heater 24. A reactivation air fan 26 may be arranged for drawing the reactivation air from air that surrounds the desiccant dehumidifier 1 and urging it to flow through the reactivation section 14 of the desiccant rotor 2 in order to cause the moisture trapped in the reactivation section 14 to be released therefrom into the reactivation airflow 18. A reactivation air outlet 20 is located downstream of the reactivation section 14 of the desiccant rotor 2 for exhausting the moist reactivation airflow 18 outside an enclosed space wherein the desiccant dehumidifier 1 is situated. A particle detector 30 is arranged at the desiccant dehumidifier 1 for detecting particles in the air that surrounds the desiccant dehumidifier 1.

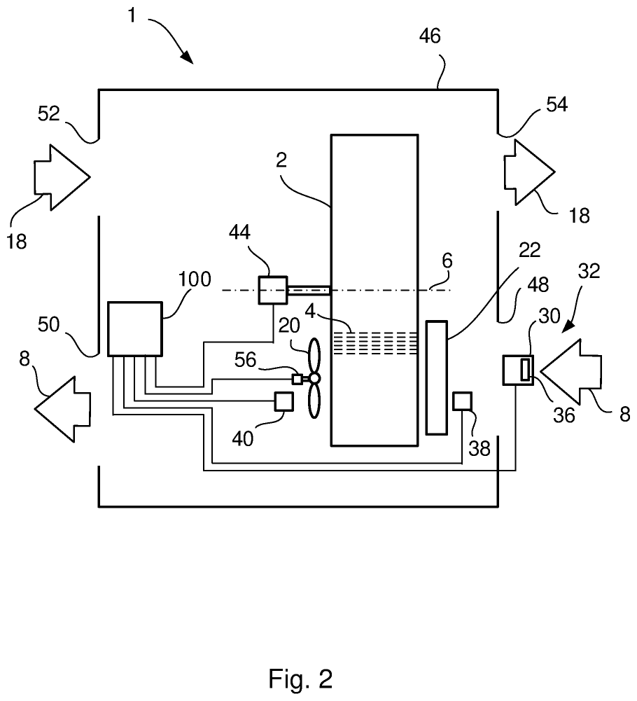

FIG. 2 schematically illustrates a particle protection device 32 for the desiccant dehumidifier 1 according to an example. The desiccant dehumidifier 1 comprising the desiccant rotor 2, which is provided with channels 4, the filter element 22 for separating particles from a process airflow 8, and the process air fan 20 for generating the process airflow 8 through the channels 4 of the desiccant rotor 2 and through the filter element 22. The particle protection device 32 comprises a control device 100, and the particle detector 30 arranged in communication with the control device 100 and configured to be arranged at the desiccant dehumidifier 1 to determine the particle concentration in the air that surrounds the desiccant dehumidifier 1 and which surrounding air should be processed by the desiccant dehumidifier 1. The particle detector 30 is adapted to be arranged at the filter element 22 in the process airflow 8 upstream of the filter element 22. It is possible to arrange the particle detector 30 in the filter element 22, so that the particle detector 30 and constitutes an integrated part of the filter element 22. The particle detector 30 may comprise an optical detector element 36 for detecting the particle concentration in the air that surrounds the desiccant dehumidifier 1. The control device 100 is configured to determine the particle concentration in the air that surrounds the desiccant dehumidifier 1 and that should be processed by the desiccant dehumidifier 1. The control device 100 is configured to deactivate the process air fan 20 when the particle concentration in the air is above a threshold value. In addition, the control device 100 may be configured to deactivate the process air fan 20 when the particle size is above a threshold value. The control device 100 may be configured to deactivate the process air fan 20 after a specific time has elapsed after that the first particle has been detected. Several parameters and threshold values can be defined and set as to regulate the exact behavior of the process air fan 20 during different conditions: for instance, a first threshold value could initiate a reduction of airflow, while a second threshold value could initiate a total stop of the process air fan speed.

The particle protection device 32 further comprising a first pressure sensor 38 adapted to be arranged upstream of the filter element 22 and a second pressure sensor 40 adapted to be arranged downstream of the filter element 22. The desiccant rotor 2 is connected to a propulsion unit 44, such as a motor, for rotating the desiccant rotor 2. The propulsion unit 44 is connected to the control device 100. The desiccant rotor 2 comprises a housing 46, which is provided with a process air inlet opening 48, a process air outlet opening 50, a reactivation air inlet opening 52 and the reactivation air outlet opening 54. The particle detector is connected to the control device 100. The process air fan 20 is driven by a process air fan motor 56. The process air fan motor 56 is connected to the control device 100. The first and second pressure sensors 38, 40 are connected to the control device 100.

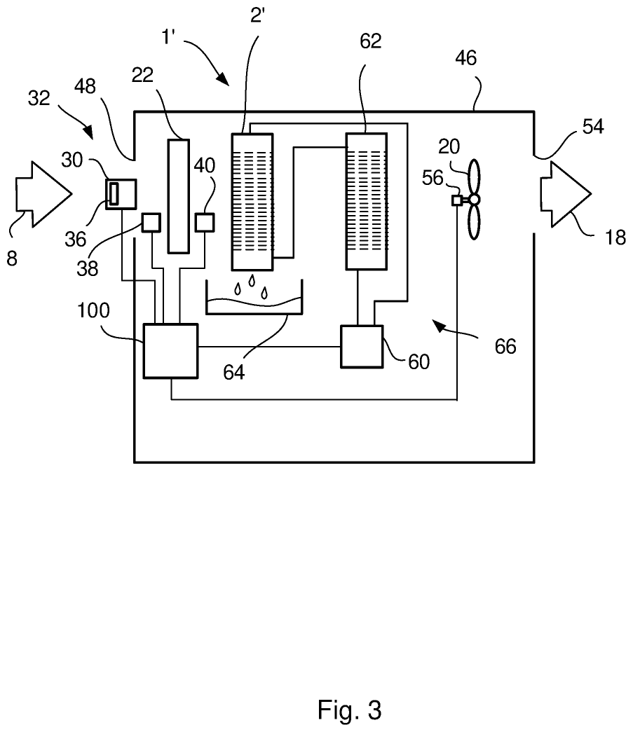

FIG. 3 schematically illustrates a particle protection device 32 for a condensate dehumidifier according to an example. The dehumidifying element 2′ in the condensate dehumidifier 1′ comprises an evaporator 2′. The process air fan 20 in the dehumidifier is configured to generate a process airflow 8 through the evaporator 2′. The evaporator 2′ should be protected from clogging by particles in the process airflow 8.

The filter element 22 will separating particles from the process airflow 8 and thus prevent the particles from reaching the evaporator 2′.

The particle protection device 32 comprises a control device 100, and the particle detector 30 arranged in communication with the control device 100 and configured to be arranged at the condensate dehumidifier 1′ to determine the particle concentration in the air that surrounds the condensate dehumidifier 1′ and which surrounding air should be processed by the condensate dehumidifier 1′. The particle detector 30 is adapted to be arranged at the filter element 22 in the process airflow 8 upstream of the filter element 22. It is possible to arrange the particle detector 30 in the filter element 22, so that the particle detector 30 and constitutes an integrated part of the filter element 22. The particle detector 30 may comprise an optical detector element 36 for detecting the particle concentration in the air that surrounds the condensate dehumidifier 1′. The control device 100 is configured to determine the particle concentration in the air that surrounds the condensate dehumidifier 1′ and that should be processed by the condensate dehumidifier 1′. The control device 100 is configured to deactivate the process air fan 20 when the particle concentration in the air is above a threshold value. In addition, the control device 100 may be configured to deactivate the process air fan 20 when the particle size is above a threshold value. The control device 100 may be configured to deactivate the process air fan 20 after a specific time has elapsed after that the first particle has been detected. Several parameters and threshold values can be defined and set as to regulate the exact behavior of the process air fan 20 during different conditions: for instance, a first threshold value could initiate a reduction of airflow, while a second threshold value could initiate a total stop of the process air fan speed.

The particle protection device 32 further comprising a first pressure sensor 38 adapted to be arranged upstream of the filter element 22 and a second pressure sensor 40 adapted to be arranged downstream of the filter element 22. The particle detector is connected to the control device 100. The process air fan 20 is driven by a process air fan motor 56. The process air fan motor 56 is connected to the control device 100. The first and second pressure sensors 38, 40 are connected to the controt device 100.

The evaporator 2′ is connected to a compressor 60. A condenser 62 is also connected to the compressor 60. The evaporator 2′, condenser 62 and compressor 60 are parts of a refrigeration device 66. The condensate dehumidifier 1′ condenses moisture in the air, which moisture thus is removed from the air and collected as water in a container 64. Thereafter, the dried air is reheated by the condenser 62 of the refrigeration device of the dehumidifier. Finally, the dehumidified, re-warmed airflow is released into the ambient space as dried airflow 18 through an outlet opening 54 in a housing of the condensate dehumidifier 1′.

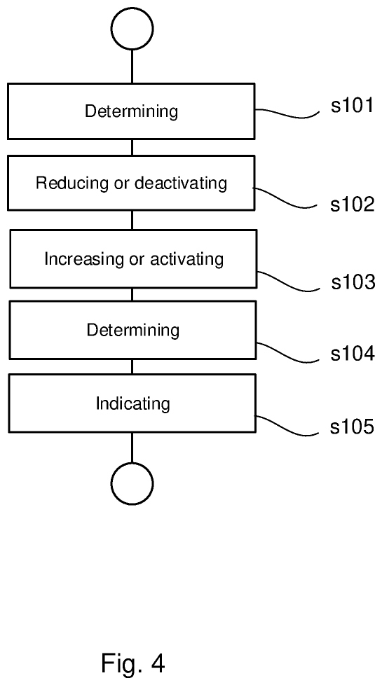

FIG. 4 shows a flow chart for a method, performed by a control device 100 of a particle protection device 32 according to an example. The method thus relates to the particle protection device 32 for a dehumidifier 1, 1′ disclosed in FIGS. 1-3. The dehumidifier 1, 1′ comprising a dehumidifying element 2, configured to separate moisture from air, a filter element 22 for separating particles from a process airflow 8, and a process air fan 20 for generating the process airflow 8 through the dehumidifying element and through the filter element 22.

The method comprising the steps of determining s101 the particle concentration in the air that surrounds the dehumidifier 1, 1′ and that should be processed by the dehumidifier 1, 1′ by means of a particle detector 30 arranged at the dehumidifier 1, 1′, and reducing or deactivating s102 the process airflow 8 when the particle concentration in the air is above a threshold value.

According to an aspect, the method comprises the further step of increasing or activating s103 the process airflow 8 when the particle concentration in the air is below the threshold value.

According to an aspect, the method comprises the further steps of determining s104 the pressure difference between a pressure detected by a first pressure sensor 38 arranged upstream of the filter element 22 and second pressure sensor 40 arranged downstream of the filter element 22, and indicating s105 when the determined pressure difference is above a threshold value.

FIG. 4 schematically illustrates a computer or a device 500 according to an example. The control device 100 of the particle protection device 32 may in a version comprise the device 500. The device 500 comprises a non-volatile memory 520, a data processing unit 510 and a read/write memory 550. The non-volatile memory 520 has a first memory element 530 in which a computer programme, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer programme P which comprises routines for performing the safety method. The programme P may be stored in an executable form or in a compressed form in a memory 560 and/or in a read/write memory 550.

Where the data processing unit 510 is described as performing a certain function, it means that the data processing unit 510 effects a certain part of the programme stored in the memory 560 or a certain part of the programme stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicating with the data processing unit 510 via a data bus 514.

When data are received on the data port 599, they are stored temporarily in the second memory element 540. When input data received have been temporarily stored, the data processing unit 510 is prepared to effect code execution as described above.

Parts of the methods herein described may be effected by the device 500 by means of the data processing unit 510 which runs the programme stored in the memory 560 or the read/write memory 550. When the device 500 runs the programme, methods herein described are executed.

The foregoing description of the examples has been furnished for illustrative and descriptive purposes. It is not intended to be exhaustive, or to limit the examples to the variants described. Many modifications and variations will obviously be apparent to one skilled in the art. The examples have been chosen and described in order to best explicate principles and practical applications, and to thereby enable one skilled in the art to understand the examples in terms of its various examples and with the various modifications that are applicable to its intended use. The components and features specified above may, within the framework of the examples, be combined between different examples specified.

1. A particle protection device for a dehumidifier, the dehumidifier comprising:
a dehumidifying element, configured to separate moisture from air;
a filter element for separating particles from a process airflow; and
a process air fan for generating the process airflow through the dehumidifying element and through the filter element;
wherein the particle protection device comprises:
a control device; and
a particle detector arranged in communication with the control device and configured to be arranged at the dehumidifier to determine the particle concentration in the air that surrounds the dehumidifier and that should be processed by the dehumidifier.

2. The device according to claim 1, wherein the dehumidifying element comprises a desiccant rotor of a desiccant dehumidifier, which desiccant rotor is provided with a plurality of channels, and wherein the process air fan is configured to generate the process airflow through the channels of the desiccant rotor.

3. The device according to claim 1, wherein the dehumidifying element comprises an evaporator of a condensate dehumidifier, and wherein the process air fan is configured to generate the process airflow through the evaporator of a condensate dehumidifier.

4. The device according to any one of the preceding claim 1, wherein the particle detector is adapted to be arranged at the filter element in the process airflow upstream of the filter element.

5. The device according to claim 1, wherein the particle detector is adapted to be arranged in the filter element and constitutes an integrated part of the filter element.

6. The device according to claim 1, wherein the particle detector comprises an optical detector element for detecting the particle concentration.

7. The device according to claim 1, wherein the control device is configured to determine the particle concentration in the air that surrounds the dehumidifier and which air should be processed by the dehumidifier.

8. The device according to claim 7, wherein the control device is configured to reduce the process airflow when the particle concentration in the air is above a threshold value.

9. The device according to claim 7, wherein the control device is configured to deactivate the process airflow when the particle concentration in the air is above a threshold value.

10. The device according to claim 1, further comprising:
a first pressure sensor adapted to be arranged upstream of the filter element; and
a second pressure sensor adapted to be arranged downstream of the filter element.

11. A dehumidifier, comprising the particle protection device according to claim 1.

12. A method, performed by a control device of a particle protection device, for protecting a dehumidifier from particles, the dehumidifier comprising:
a dehumidifying element, configured to separate moisture from air;
a filter element for separating particles from a process airflow; and
a process air fan for generating the process airflow through the dehumidifying element and through the filter element;
the method comprises the steps of:
determining the particle concentration in the air that surrounds the dehumidifier and that should be processed by the dehumidifier by means of a particle detector arranged at the dehumidifier; and
reducing or deactivating the process airflow when the particle concentration in the air is above a threshold value.

13. The method according to claim 12, further comprising the step of:
increasing or activating the process airflow when the particle concentration in the air is below the threshold value.

14. The method according to claim 12, further comprising the steps of:
determining the pressure difference between a pressure detected by a first pressure sensor arranged upstream of the filter element and a second pressure sensor arranged downstream of the filter element; and
indicating when the determined pressure difference is above a threshold value.

15. A computer program embodied in a non-transitory computer-readable medium comprising instructions which, when the program is executed by a computer, cause the computer to carry out the method according to claim 12.

16. A non-transitory computer-readable medium comprising instructions, which when executed by a computer, cause the computer to carry out the method according to claim 12.
